(19) United States
(12) Patent Application Publication
(10) Pub. No.: US 2026/0187951 A1
(43) Pub. Date: Jul. 2, 2026

(54) METHOD FOR PROVIDING FULL-BODY MOTION INTERACTION USING MULTIPLE MOBILE CAMERAS AND APPARATUS THEREFOR

(71) Applicant: ELECTRONICS AND TELECOMMUNICATIONS RESEARCH INSTITUTE, Daejeon (KR)

(72) Inventors: Sung-Jin HONG, Daejeon (KR); Kyung-Kyu KANG, Daejeon (KR); Youn-Hee GIL, Daejeon (KR); Hye-Sun KIM, Daejeon (KR); Seong-Min BAEK, Daejeon (KR); Cho-Rong YU, Daejeon (KR)

(21) Appl. No.: 19/296,131

(22) Filed: Aug. 11, 2025

(30) Foreign Application Priority Data
Dec. 26, 2024 (KR) 10-2024-0197422

(51) Int. Cl. G06T 19/20; G06T 7/246; G06T 7/73; G06T 13/40; G06V 10/764

(52) U.S. Cl. CPC G06T 19/20; G06T 7/246; G06T 7/73; G06T 13/40; G06V 10/764; G06T 2219/2004; G06V 2201/07

(57) ABSTRACT

Disclosed herein are a method for providing full-body motion interaction using multiple mobile cameras and an apparatus for the same. The method, performed by the apparatus, includes estimating a joint outside the field of view of a user camera by using self-joint detection information captured by multiple user cameras mounted on a user, searching for the camera of an additional user located in the same space as the user based on landmark information extracted from images captured by the multiple user cameras, selecting candidate joint information for the joint outside the field of view of the user camera in other-user joint detection information captured by the camera of the additional user, reconstructing full-body joints of the user by combining estimated joint information with the candidate joint information, and providing interaction for a full-body motion of the user based on the reconstructed full-body joints.

### CROSS REFERENCE TO RELATED APPLICATION

This application claims the benefit of Korean Patent Application No. 10-2024-0197422, filed Dec. 26, 2024, which is hereby incorporated by reference in its entirety into this application.

### BACKGROUND OF THE INVENTION

### 1. Technical Field

The present disclosure relates generally to technology for providing full-body motion interaction using multiple mobile cameras, and more particularly to technology for reconstructing 3D full-body motions of a user and providing interaction using multiple mobile cameras in order to more accurately provide interaction with a virtual or real object in real/virtual environments.

### 2. Description of Related Art

Accurately estimating 3D joints of users is a crucial factor in providing interaction with objects to users who experience a virtual or extended reality (XR) environment. In general, a method of estimating joints using mobile sensors attached near the user's head is used, but this method has a limitation that it is difficult to accurately estimate full-body joints when the joint area to be estimated falls outside the field of view of a camera or is occluded by obstacles.

Also, many methods of using fisheye lenses have been proposed to expand the scope of interaction. However, a fisheye lens causes significant distortion as the distance from the center of the lens increases, which results in a decrease in the accuracy of joint estimation. In order to solve this problem, high-end Head Mounted Displays (HMDs) incorporate additional depth cameras, thereby providing accurate interaction.

Also, in order to improve the estimation accuracy of invisible or occluded joints or joints that are inaccurate due to distortion, a method of combining a wide-angle lens having a narrower field of view than a fisheye lens with multiple Inertial Measurement Unit (IMU) sensors has been proposed to estimate full-body joints of a user. However, this method imposes many constraints on the usage environment due to the inconvenience of wearing additional IMU sensors and severe noise in environments with a large amount of metal.

Currently, mobile XR products with fields of view of normal lenses are only used facing the user's front and provide only a limited range of hand-based interaction, and they lack support for full-body joint interaction.

### Documents of Related Art

(Patent Document 1) Korean Patent Application Publication No. 10-2024-0072397, published on May 24, 2024 and titled “Method and apparatus for providing user augmented reality interaction based on mobile devices”.

### SUMMARY OF THE INVENTION

An object of the present disclosure is to provide full-body motion interaction by more accurately estimating 3D full-body joints using multiple RGBD cameras with standard lenses, rather than using fisheye or wide-angle lenses.

Another object of the present disclosure is to use cameras with standard lenses installed around the head of a user, thereby more accurately estimating joints even in an area that is outside the field of view of a camera or heavily occluded.

A further object of the present disclosure is to support interaction with a virtual or real object using a reconstructed 3D full-body motion in an XR environment.

In order to accomplish the above objects, a method for providing full-body motion interaction using multiple mobile cameras, performed by an apparatus for providing full-body motion interaction, according to the present disclosure includes estimating a joint outside the field of view of a user camera by using self-joint detection information captured by multiple user cameras mounted on a user, searching for a camera of an additional user located in the same space as the user based on landmark information extracted from images captured by the multiple user cameras, selecting candidate joint information for the joint outside the field of view of the user camera in other-user joint detection information captured by the camera of the additional user, reconstructing full-body joints of the user by combining estimated joint information with the candidate joint information, and providing interaction for a full-body motion of the user based on the reconstructed full-body joints.

Here, estimating the joint may include identifying body regions of the user visible in the field of view of the user camera, setting a reference point for each of the identified body regions, and estimating the direction of the joint outside the field of view of the user camera based on principal component analysis considering the reference point.

Here, the principal component analysis may comprise inferring a position of at least one adjacent joint from the reference point and setting a weight for the position of the adjacent joint.

Here, the weight may be set higher as the position is closer to the reference point, and may be set lower as the position is more distant from the reference point.

Here, the adjacent joint may correspond to a joint directly connected to a joint corresponding to the reference point in terms of body structure.

Here, searching for the camera of the additional user may include extracting the landmark information based on the images captured by the multiple user cameras, setting a global coordinate system by combining the landmark information, determining the position and orientation of the user in the global coordinate system, and detecting the camera of the additional user based on the position and orientation of the user.

Here, selecting the candidate joint information may include converting an image captured by the camera of the additional user into the global coordinate system and generating the other-user joint detection information by classifying joint information of the user in the image captured by the camera of the additional user based on the position and orientation of the user.

Here, the candidate joint information may be selected to correspond to other-user joint detection information of a camera of an additional user selected in consideration of joint detection reliability of each camera, and when multiple additional users' cameras having similar reliability are found, the candidate joint information may be selected by further considering a distance from the user in the global coordinate system.

Here, the multiple user cameras may be mounted around the head of the user and may include a front camera for capturing in a direction in front of the user, a left camera for capturing in a direction toward the ground from the left side of the user, and a right camera for capturing in the direction toward the ground from the right side of the user.

Here, the front camera, the left camera, and the right camera may operate in a unified coordinate system and correspond to RGBD cameras with standard lenses.

Also, an apparatus for providing full-body motion interaction using multiple mobile cameras according to an embodiment of the present disclosure includes a processor for estimating a joint outside the field of view of a user camera by using self-joint detection information captured by multiple user cameras mounted on a user, searching for a camera of an additional user located in the same space as the user based on landmark information extracted from images captured by the multiple user cameras, selecting candidate joint information for the joint outside the field of view of the user camera in other-user joint detection information captured by the camera of the additional user, reconstructing full-body joints of the user by combining estimated joint information with the candidate joint information, and providing interaction for a full-body motion of the user based on the reconstructed full-body joints; and memory for storing the full-body joints.

Here, the processor may identify body regions of the user visible in the field of view of the user camera, set a reference point for each of the identified body regions, and estimate the direction of the joint outside the field of view of the user camera based on principal component analysis considering the reference point.

Here, the principal component analysis may comprise inferring a position of at least one adjacent joint from the reference point and setting a weight for the position of the adjacent joint.

Here, the weight may be set higher as the position is closer to the reference point, and may be set lower as the position is more distant from the reference point.

Here, the adjacent joint may correspond to a joint directly connected to a joint corresponding to the reference point in terms of body structure.

Here, the processor may extract the landmark information based on the images captured by the multiple user cameras, set a global coordinate system by combining the landmark information, determine the position and orientation of the user in the global coordinate system, and detect the camera of the additional user based on the position and orientation of the user.

Here, the processor may convert an image captured by the camera of the additional user into the global coordinate system and generate the other-user joint detection information by classifying joint information of the user in the image captured by the camera of the additional user based on the position and orientation of the user.

Here, the candidate joint information may be selected to correspond to other-user joint detection information of a camera of an additional user selected in consideration of joint detection reliability of each camera, and when multiple additional users' cameras having similar reliability are found, the candidate joint information may be selected by further considering a distance from the user in the global coordinate system.

Here, the multiple user cameras may be mounted around the head of the user and may include a front camera for capturing in a direction in front of the user, a left camera for capturing in a direction toward the ground from the left side of the user, and a right camera for capturing in the direction toward the ground from the right side of the user.

Here, the front camera, the left camera, and the right camera may operate in a unified coordinate system and correspond to RGBD cameras with standard lenses.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a system for providing full-body motion interaction using multiple mobile cameras according to an embodiment of the present disclosure;

FIG. 2 is a flowchart illustrating a method for providing full-body motion interaction using multiple mobile cameras according to an embodiment of the present disclosure;

FIG. 3 is a configuration diagram illustrating in detail a process of providing full-body motion interaction using multiple mobile cameras according to the present disclosure;

FIGS. 4 to 6 are views illustrating examples of a user camera and a field of view according to the present disclosure;

FIG. 7 is a view illustrating an example of an image captured by a right camera according to the present disclosure;

FIG. 8 is a view illustrating in detail the self-directed joint estimation process in the process illustrated in FIG. 3;

FIGS. 9 and 10 are views illustrating an example of estimating the position of an undetected joint through two joints according to the present disclosure;

FIG. 11 is a view illustrating in detail the user information sharing process in the process illustrated in FIG. 3;

FIG. 12 is a view illustrating an example of reconstructing a joint of a user using joint information captured by the camera of another user according to the present disclosure; and

FIG. 13 is a view illustrating an apparatus for providing full-body motion interaction using multiple mobile cameras according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

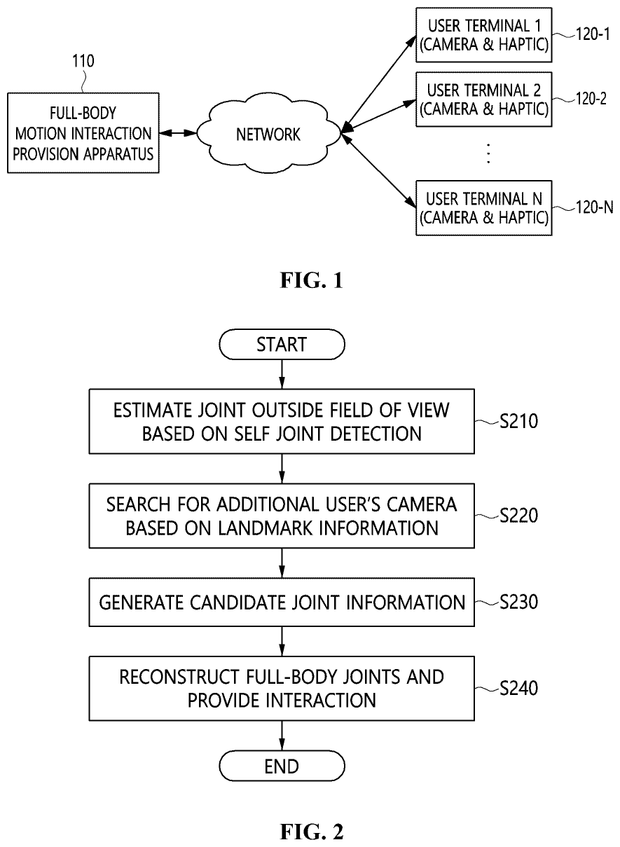

FIG. 1 is a view illustrating a system for providing full-body motion interaction using multiple mobile cameras according to an embodiment of the present disclosure.

Referring to FIG. 1, the system for providing full-body motion interaction using multiple mobile cameras according to an embodiment of the present disclosure includes a full-body motion interaction provision apparatus 110, user terminals 120-1 to 120-N, and a network.

The full-body motion interaction provision apparatus 110 estimates a joint outside the field of view of a user camera by using self-joint detection information captured by multiple user cameras mounted on a user.

Here, the multiple user cameras are mounted around the head of the user and may include a front camera for capturing in a direction in front of the user, a left camera for capturing in a direction toward the ground from the left side of the user, and a right camera for capturing in the direction toward the ground from the right side of the user.

Here, the front camera, the left camera, and the right camera operate in a unified coordinate system, and may correspond to RGBD cameras with standard lenses.

Here, the body regions of the user visible in the field of view of the user camera may be identified, a reference point for each of the identified body regions may be set, and the direction of the joint outside the field of view of the user camera may be estimated based on principal component analysis considering the reference point.

Here, the principal component analysis may comprise inferring the position of at least one adjacent joint from the reference point and setting a weight for the position of the adjacent joint.

Here, the weight may be set higher as the position is closer to the reference point, and may be set lower as the position is more distant from the reference point.

Here, the adjacent joint may correspond to a joint directly connected to a joint corresponding to the reference point in terms of body structure.

Also, the full-body motion interaction provision apparatus 110 searches for the camera of an additional user located in the same space as the user based on landmark information extracted from the images captured by the multiple user cameras.

Here, the landmark information may be extracted based on the images captured by the multiple user cameras, a global coordinate system may be set by combining the landmark information, the position and orientation of the user may be determined in the global coordinate system, and the camera of the additional user may be detected based on the position and orientation of the user.

Also, the full-body motion interaction provision apparatus 110 selects candidate joint information for the joint outside the field of view of the user camera in other-user joint detection information captured by the camera of the additional user.

Here, an image captured by the camera of the additional user is converted into the global coordinate system, and the joint information of the user in the image captured by the camera of the addition user is classified based on the position and orientation of the user, whereby the other-user joint detection information may be generated.

Here, the candidate joint information is selected to correspond to other-user joint detection information of the camera of an additional user selected in consideration of joint detection reliability of each camera, and when multiple additional users' cameras having similar reliability are found, the candidate joint information may be selected by further considering the distance from the user in the global coordinate system.

Also, the full-body motion interaction provision apparatus 110 reconstructs the full-body joints of the user by combining estimated joint information with the candidate joint information and provides interaction for a full-body motion of the user based on the reconstructed full-body joints.

The user terminals 120-1 to 120-N may correspond to terminals worn or held by respective users that use the system according to the present disclosure.

Here, the user terminals 120-1 to 120-N may include multiple user cameras and a haptic device.

For example, the user terminals 120-1 to 120-N may provide the images captured by the multiple user cameras to the full-body motion interaction provision apparatus 110 through the network and may receive interaction for the full-body motion of the user from the full-body motion interaction provision apparatus 110 and implement the same with the haptic device.

FIG. 2 is a flowchart illustrating a method for providing full-body motion interaction using multiple mobile cameras according to an embodiment of the present disclosure.

Referring to FIG. 2, in the method for providing full-body motion interaction using multiple mobile cameras according to an embodiment of the present disclosure, the full-body motion interaction provision apparatus estimates a joint outside the field of view of a user camera by using self-joint detection information captured by multiple user cameras mounted on a user at step S210.

Here, the multiple user cameras are mounted around the head of the user and may include a front camera for capturing in a direction in front of the user, a left camera for capturing in a direction toward the ground from the left side of the user, and a right camera for capturing in the direction toward the ground from the right side of the user.

Here, the front camera, the left camera, and the right camera may operate in a unified coordinate system and correspond to RGBD cameras with standard lenses.

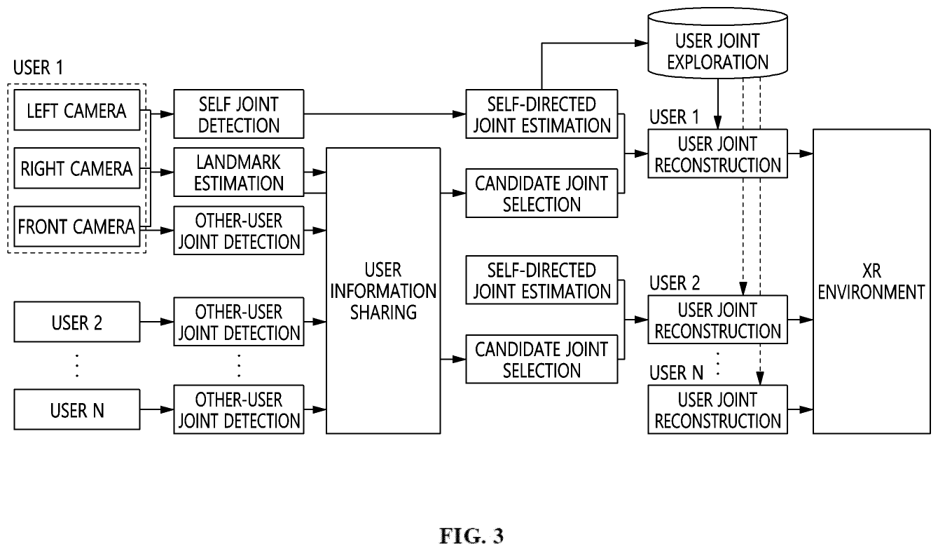

That is, the present disclosure is for reconstructing body joints of a user using RGBD cameras attached to the body of the user and providing an interface in a virtual environment, and may operate with the configuration illustrated in FIG. 3.

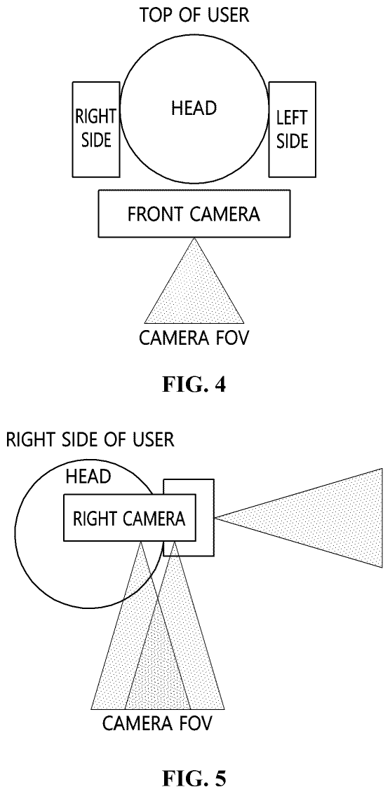

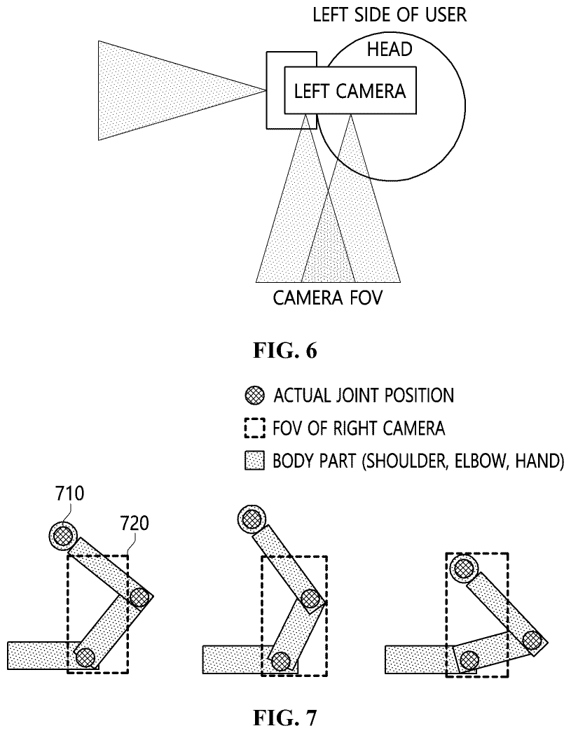

For example, three RGBD cameras may be attached around the head of the user. The front camera may be placed to face the front of the user, as illustrated in FIG. 4, and the two additional cameras may be placed on the left and right sides of the user, oriented toward the ground, as illustrated in FIGS. 5 and 6. Here, the cameras may be RGBD cameras, and the Field-Of-View (FOV) thereof may correspond to that of cameras with standard lenses, such as a cam. Here, the respective cameras may be attached to a fixed structure and unified under a single coordinate system (user coordinate system).

Here, the body regions of the user visible in the field of view of the user camera may be identified, a reference point may be set for each of the identified body regions, and the direction of the joint outside the field of view of the user camera may be estimated based on principal component analysis considering the reference point.

Here, principal component analysis may comprise inferring the position of at least one adjacent joint from the reference point and setting a weight for the position of the adjacent joint.

Here, the weight may be set higher as the position is closer to the reference point, and may be set lower as the position is more distant from the reference point.

Here, the adjacent joint may correspond to a joint directly connected to a joint corresponding to the reference point in terms of body structure.

For example, the user's own joints and the joints of others may be detected using the three cameras attached to the body of the user.

Referring to FIG. 3, through ‘self-joint detection’, the 3D joints of the body parts of the user may be detected using three cameras. Here, not only the shoulder joint of the user but also the left elbow that may be within the left camera area may be detected using the left camera, and the hand joint located in front of the user may be detected using the front camera.

Also, referring to FIG. 3, through ‘other-user joint detection’, the 3D joints of an additional user, other than the user's own body joints, may also be detected using the front camera. The 3D joints of the additional user detected in this way may be used when the additional user detects his/her joints in the future.

Here, through ‘self-directed joint estimation’ in FIG. 3, joints that are outside the FOV of the camera may be inferred from information acquired from the three cameras. In general, when an image is captured by a camera with a standard lens, the body joints may often be outside the FOV 720 of the camera, as shown in FIG. 7. The shoulder joint, which is close to the position of the head to which the camera is attached, is usually visible in the FOV of the camera, but elbows or hands with a high degree of freedom are often outside the FOV of the camera.

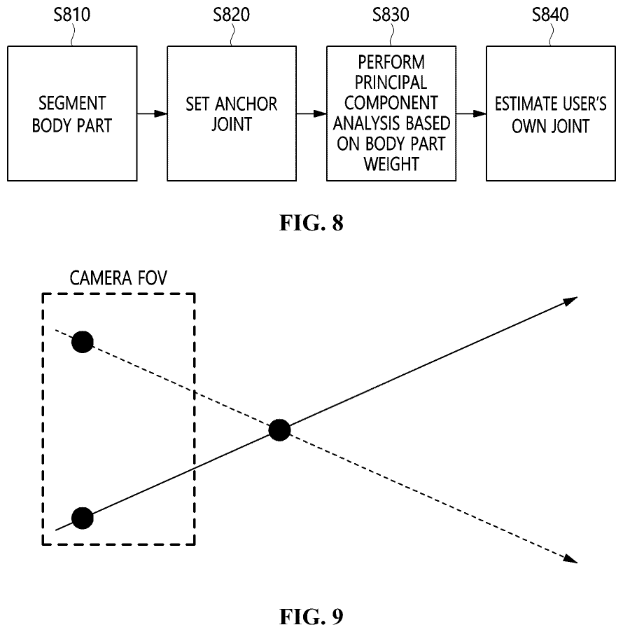

Therefore, in the present disclosure, the body part outside the FOV of the camera may be estimated through the process illustrated in FIG. 8.

Referring to FIG. 8, the method for providing full-body motion interaction according to an embodiment of the present disclosure may be subdivided into processes of segmenting body parts at step S810, setting an anchor joint at step S820, performing principal component analysis based on a body part weight at step S830, and estimating the user's own joint at step S840, whereby the body part outside the FOV of the camera may be estimated.

First, segmenting the body parts at step S810 may comprise identifying the body regions of a user visible from the first-person view. For example, a shoulder, an upper arm, a forearm, a hand, and the like may be identified.

Subsequently, setting the anchor joint at step S820 may comprise setting a reference point using the joint observed in the FOV of the camera. For example, the parts corresponding to the actual joint positions 710 in FIG. 7 may be set as reference points.

Subsequently, the principal component analysis based on the body part weight at step S830 may comprise inferring the positions of adjacent joints outside the FOV of the camera by using the set reference points.

Here, an adjacent joint may indicate a directly connected joint in terms of body structure. For example, the adjacent joints of an elbow may correspond to a wrist and a shoulder, and the adjacent joints of a shoulder may correspond to a neck and an elbow.

Also, the principal component analysis based on the body part weight at step S830 may comprise performing principal component analysis on the region extracted from the body part segment by setting the position of the reference point (the anchor joint) as the starting point and determining the direction in which the invisible joint is located from the visible joint (the starting point).

Here, the body region that is not adjacent to the starting point may be assigned a low weight. For example, when the position of the hand is estimated, the body region of the upper arm may be excluded from the principal component analysis.

Also, if it is far away from the anchor joint, the adjacent body region may also be assigned a low weight. For example, when principal component analysis is performed to estimate an elbow that is invisible from a shoulder joint, a region corresponding to part of an upper arm that is observed at the position far away from the shoulder may be assigned a low weight.

Subsequently, estimating the user's own joint at step S840 may comprise estimating the position of the joint outside the FOV of the camera.

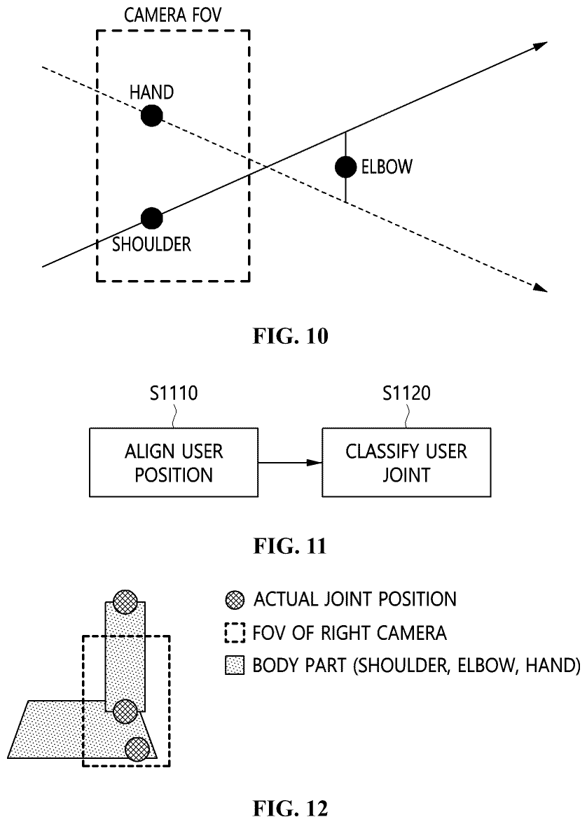

Here, the direction of the joint, estimated through the principal component analysis performed by setting the reference point (the anchor point) as the starting point, is combined with the length of the joint, whereby the position of the joint outside the FOV of the camera may be estimated. If two or more adjacent joints are detected (e.g., if a shoulder and a hand are detected but an elbow is not detected), as illustrated in FIGS. 9 to 10, the approximate intersection of the vectors starting from the detected two joints or the median point of the line segment indicating the distance between the two vectors may be determined to be the position of the joint.

Here, the length of the joint may be estimated using standard body size information or through the observed joint length information.

Also, in the method for providing full-body motion interaction using multiple mobile cameras according to an embodiment of the present disclosure, the full-body motion interaction provision apparatus searches for the camera of an addition user located in the same space as the user based on landmark information extracted from images captured by the multiple user cameras at step S220.

Here, the landmark information may be extracted based on the images captured by the multiple user cameras, a global coordinate system may be set by combining the landmark information, the position and orientation of the user may be determined in the global coordinate system, and the camera of the additional user may be detected based on the position and orientation of the user.

Here, the landmark information is information about a background or fixed object, and it may be used as the information for estimating the position and orientation of each of the users in the same space.

For example, referring to FIG. 3, pieces of landmark information based on which the position and orientation of the user can be estimated in the current space may be estimated through ‘landmark estimation’.

Here, the estimated landmark information may be delivered to the process of ‘user information sharing’, along with joint information of others.

For example, referring to FIG. 11, in the method for providing full-body motion interaction, user information sharing may be performed through the process subdivided into user position alignment at step S1110 and user joint classification at step S1120.

First, the user position alignment at step S1110 may comprise setting a reference coordinate system (a global coordinate system) by combining the pieces of landmark information estimated by the user and determining the position and orientation of the user in the set coordinate system.

Subsequently, the user joint classification at step S1120 may comprise receiving other-user joint detection information, which is detected when the user is in the same space, converting the other-user joint detection information into the reference coordinate system, and classifying the joint information corresponding to each user.

Here, the joint of each user may be classified using clustering based on the distance between joints expressed in the global coordinate system or the feature similarity between the body regions of the user.

Also, in the method for providing full-body motion interaction using multiple mobile cameras according to an embodiment of the present disclosure, the full-body motion interaction provision apparatus selects candidate joint information for the joint outside the field of view of the user camera in the other-user joint detection information captured by the camera of the additional user at step S230.

Here, the image captured by the camera of the additional user is converted into the global coordinate system, and the joint information of the user is classified in the image captured by the camera of the additional user based on the position and orientation of the user, whereby the other-user joint detection information may be generated.

Here, the candidate joint information may be selected to correspond to other-user joint detection information of the camera of an additional user selected in consideration of joint detection reliability of each camera, and when multiple additional users' cameras having similar reliability are found, the candidate joint information may be selected by further considering the distance from the user in the global coordinate system.

For example, referring to FIG. 3, through ‘candidate joint selection’, suitable joints may be selected from among candidates that are determined to be the user's own joints in the user joint classification information.

Here, the reliability that is measured when joints are detected by each camera may be used, and when cameras have similar reliability, information of the camera that is closer to the user may be selected and used as the candidate joint.

Also, through ‘user joint reconstruction’ illustrated in FIG. 3 the full-body joints of the user may be reconstructed using the information acquired through ‘self-directed joint estimation’, which is joint information detected by the user, and the information acquired through ‘candidate joint selection’, which is joint information detected by the additional user.

For example, when it is difficult to reconstruct joints because consecutive joints are outside the FOV of the camera as illustrated in FIG. 12 or the joints are heavily occluded, the joints may be more accurately reconstructed using the joint information detected by another user.

However, when reconstructing joints, the joint detected through ‘self-joint detection’ may have higher priority than information acquired through ‘other-user joint detection’, and the full-body joints of the user may be reconstructed using the angle between the joints detected by the additional user and the length information of the joints.

Also, when a single user is present, similar joint information accumulated in a database may be collected using information acquired through ‘self-directed joint estimation’ and information acquired through ‘user joint exploration’. By assuming that the information collected in this way is joint information detected by an additional user, this information may be used to reconstruct the joints of the user.

Also, in the method for providing full-body motion interaction using multiple mobile cameras according to an embodiment of the present disclosure, the full-body motion interaction provision apparatus constructs the full-body joints of the user by combining estimated joint information with the candidate joint information and provides interaction for a full-body motion of the user based on the reconstructed full-body joints at step S240.

That is, the full-body joint information of the user, which is finally reconstructed through the process illustrated in FIG. 3, may be used as a user full-body motion interface in a virtual environment.

Through the above-described method for providing full-body motion interaction using multiple mobile cameras, full-body motion interaction may be provided by more accurately estimating 3D full-body joints using multiple RGBD cameras with standard lenses, rather than using fisheye or wide-angle lenses.

Also, using cameras with standard lenses installed around the head of a user, joints may be more accurately estimated even in an area that is outside the field of view of a camera or heavily occluded.

Also, interaction with a virtual or real object may be supported using a reconstructed 3D full-body motion in an XR environment.

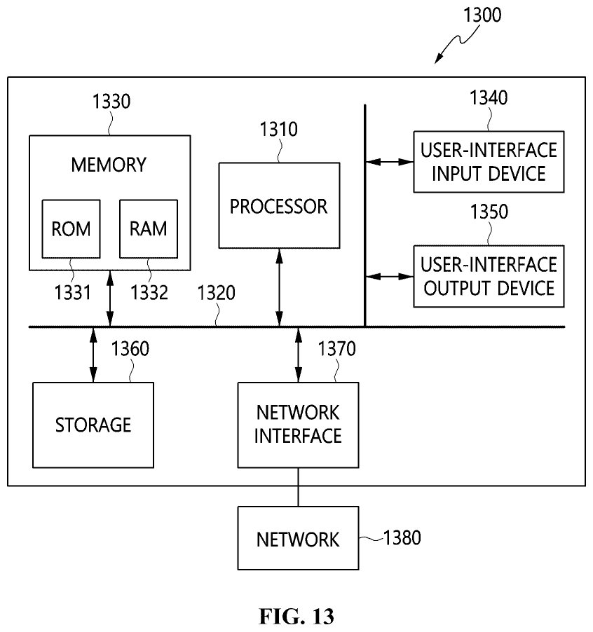

FIG. 13 is a view illustrating an apparatus for providing full-body motion interaction using multiple mobile cameras according to an embodiment of the present disclosure.

Referring to FIG. 13, the apparatus for providing full-body motion interaction using multiple mobile cameras according to an embodiment of the present disclosure may be implemented in a computer system including a computer-readable recording medium. As illustrated in FIG. 13, the computer system 1300 may include one or more processors 1310, memory 1330, a user input device 1340, a user output device 1350, and storage 1360, which communicate with each other via a bus 1320. Also, the computer system 1300 may further include a network interface 1370 connected to a network 1380. The processor 1310 may be a central processing unit or a semiconductor device for executing processing instructions stored in the memory 1330 or the storage 1360. The memory 1330 and the storage 1360 may be any of various types of volatile or nonvolatile storage media. For example, the memory may include ROM 1331 or RAM 1332.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

The processor 1310 estimates a joint outside the field of view of a user camera by using self-joint detection information captured by multiple user cameras mounted on a user.

Here, the multiple user cameras may be mounted around the head of the user and may include a front camera for capturing in a direction in front of the user, a left camera for capturing in a direction toward the ground from the left side of the user, and a right camera for capturing in the direction toward the ground from the right side of the user.

Here, the front camera, the left camera, and the right camera may operate in a unified coordinate system and correspond to RGBD cameras with standard lenses.

Here, the body regions of the user visible in the field of view of the user camera may be identified, a reference point may be set for each of the identified body regions, and the direction of the joint outside the field of view of the user camera may be estimated based on principal component analysis considering the reference point.

Here, the principal component analysis may comprise inferring the position of at least one adjacent joint from the reference point and setting a weight for the position of the adjacent joint.

Here, the weight may be set higher as the position is closer to the reference point, and may be set lower as the position is more distant from the reference point.

Here, the adjacent joint may correspond to a joint directly connected to a joint corresponding to the reference point in terms of body structure.

Also, the processor 1310 searches for a camera of an additional user located in the same space as the user based on landmark information extracted from the images captured by the multiple user cameras.

Here, the landmark information may be extracted based on the images captured by the multiple user cameras, a global coordinate system may be set by combining the landmark information, the position and orientation of the user may be determined in the global coordinate system, and the camera of the additional user may be detected based on the position and orientation of the user.

Also, the processor 1310 selects candidate joint information for the joint outside the field of view of the user camera in other-user joint detection information captured by the camera of the additional user.

Here, the image captured by the camera of the additional user is converted into the global coordinate system, and the joint information of the user is classified in the image captured by the camera of the additional user based on the position and orientation of the user, whereby the other-user joint detection information may be generated.

Here, the candidate joint information is selected to correspond to other-user joint detection information of the camera of an additional user selected in consideration of the joint detection reliability of each camera, and when multiple additional users' cameras having similar reliability are found, the candidate joint information may be selected by further considering the distance from the user in the global coordinate system.

Also, the processor 1310 reconstructs the full-body joints of the user by combining estimated joint information with the candidate joint information and provides interaction for a full-body motion of the user based on the reconstructed full-body joints.

The memory 1330 stores various kinds of information generated in the above-described apparatus for providing full-body motion interaction according to an embodiment of the present disclosure.

According to an embodiment, the memory 1330 may be separate from the apparatus for providing full-body motion interaction, and may support the function for providing full-body motion interaction. Here, the memory 1330 may operate as separate mass storage, and may include a control function for performing operations.

Meanwhile, the apparatus for providing full-body motion interaction includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Using the above-described apparatus for providing full-body motion interaction using multiple mobile cameras, full-body motion interaction may be provided by more accurately estimating 3D full-body joints using multiple RGBD cameras with standard lenses, rather than using fisheye or wide-angle lenses.

Also, using cameras with standard lenses installed around the head of a user, joints may be more accurately estimated even in an area that is outside the field of view of a camera or heavily occluded.

Also, interaction with a virtual or real object may be supported using a reconstructed 3D full-body motion in an XR environment.

According to the present disclosure, full-body motion interaction may be provided by more accurately estimating 3D full-body joints using multiple RGBD cameras with standard lenses, rather than using fisheye or wide-angle lenses.

Also, the present disclosure uses cameras with standard lenses installed around the head of a user, thereby more accurately estimating joints even in an area that is outside the field of view of a camera or heavily occluded.

Also, the present disclosure may support interaction with a virtual or real object using a reconstructed 3D full-body motion in an XR environment.

As described above, the method for providing full-body motion interaction using multiple mobile cameras and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for providing full-body motion interaction, performed by an apparatus for providing full-body motion interaction, comprising:
estimating a joint outside a field of view of a user camera by using self-joint detection information captured by multiple user cameras mounted on a user;
searching for a camera of an additional user located in a same space as the user based on landmark information extracted from images captured by the multiple user cameras;
selecting candidate joint information for the joint outside the field of view of the user camera in other-user joint detection information captured by the camera of the additional user; and
reconstructing full-body joints of the user by combining estimated joint information with the candidate joint information and providing interaction for a full-body motion of the user based on the reconstructed full-body joints.

2. The method of claim 1, wherein estimating the joint comprises:
identifying body regions of the user visible in the field of view of the user camera;
setting a reference point for each of the identified body regions; and
estimating a direction of the joint outside the field of view of the user camera based on principal component analysis considering the reference point.

3. The method of claim 2, wherein the principal component analysis comprises inferring a position of at least one adjacent joint from the reference point and setting a weight for the position of the adjacent joint.

4. The method of claim 3, wherein the weight is set higher as the position is closer to the reference point and is set lower as the position is more distant from the reference point.

5. The method of claim 3, wherein the adjacent joint corresponds to a joint directly connected to a joint corresponding to the reference point in terms of body structure.

6. The method of claim 1, wherein searching for the camera of the additional user comprises:
extracting the landmark information based on the images captured by the multiple user cameras;
setting a global coordinate system by combining the landmark information;
determining a position and orientation of the user in the global coordinate system; and
detecting the camera of the additional user based on the position and orientation of the user.

7. The method of claim 6, wherein selecting the candidate joint information comprises:
converting an image captured by the camera of the additional user into the global coordinate system; and
generating the other-user joint detection information by classifying joint information of the user in the image captured by the camera of the additional user based on the position and orientation of the user.

8. The method of claim 7, wherein the candidate joint information is selected to correspond to other-user joint detection information of a camera of an additional user selected in consideration of joint detection reliability of each camera, and when multiple additional users' cameras having similar reliability are found, the candidate joint information is selected by further considering a distance from the user in the global coordinate system.

9. The method of claim 1, wherein the multiple user cameras are mounted around a head of the user and include a front camera for capturing in a direction in front of the user, a left camera for capturing in a direction toward a ground from a left side of the user, and a right camera for capturing in the direction toward the ground from a right side of the user.

10. The method of claim 9, wherein the front camera, the left camera, and the right camera operate in a unified coordinate system and correspond to RGBD cameras with standard lenses.

11. An apparatus for providing full-body motion interaction, comprising:
a processor for estimating a joint outside a field of view of a user camera by using self-joint detection information captured by multiple user cameras mounted on a user, searching for a camera of an additional user located in a same space as the user based on landmark information extracted from images captured by the multiple user cameras, selecting candidate joint information for the joint outside the field of view of the user camera in other-user joint detection information captured by the camera of the additional user, reconstructing full-body joints of the user by combining estimated joint information with the candidate joint information, and providing interaction for a full-body motion of the user based on the reconstructed full-body joints; and
memory for storing the full-body joints.

12. The apparatus of claim 11, wherein the processor identifies body regions of the user visible in the field of view of the user camera, sets a reference point for each of the identified body regions, and estimates a direction of the joint outside the field of view of the user camera based on principal component analysis considering the reference point.

13. The apparatus of claim 12, wherein the principal component analysis comprises inferring a position of at least one adjacent joint from the reference point and setting a weight for the position of the adjacent joint.

14. The apparatus of claim 13, wherein the weight is set higher as the position is closer to the reference point and is set lower as the position is more distant from the reference point.

15. The apparatus of claim 13, wherein the adjacent joint corresponds to a joint directly connected to a joint corresponding to the reference point in terms of body structure.

16. The apparatus of claim 11, wherein the processor extracts the landmark information based on the images captured by the multiple user cameras, sets a global coordinate system by combining the landmark information, determines a position and orientation of the user in the global coordinate system, and detects the camera of the additional user based on the position and orientation of the user.

17. The apparatus of claim 16, wherein the processor converts an image captured by the camera of the additional user into the global coordinate system and generates the other-user joint detection information by classifying joint information of the user in the image captured by the camera of the additional user based on the position and orientation of the user.

18. The apparatus of claim 17, wherein the candidate joint information is selected to correspond to other-user joint detection information of a camera of an additional user selected in consideration of joint detection reliability of each camera, and when multiple additional users' cameras having similar reliability are found, the candidate joint information is selected by further considering a distance from the user in the global coordinate system.

19. The apparatus of claim 11, wherein the multiple user cameras are mounted around a head of the user and include a front camera for capturing in a direction in front of the user, a left camera for capturing in a direction toward a ground from a left side of the user, and a right camera for capturing in the direction toward the ground from a right side of the user.

20. The apparatus of claim 19, wherein the front camera, the left camera, and the right camera operate in a unified coordinate system and correspond to RGBD cameras with standard lenses.
